(19) United States
(12) Patent Application Publication
(10) Pub. No.: US 2024/0336806 A1
(43) Pub. Date: Oct. 10, 2024

(54) CURABLE FILM-FORMING COMPOSITIONS AND COATED ARTICLES PREPARED THEREWITH

(71) Applicant: PPG Industries Ohio, Inc., Cleveland, OH (US)

(72) Inventors: Ronald J. Kralic, Jr., Beaver Falls, PA (US); Hongying Zhou, Allison Park, PA (US); Steven E. Bowles, Pittsburgh, PA (US)

(73) Assignee: PPG Industries Ohio, Inc., Cleveland, OH (US)

(21) Appl. No.: 18/575,906

(22) PCT Filed: Jul. 1, 2022
(86) PCT No.: PCT/US2022/073331

§ 371 Date: Jan. 2, 2024

Related U.S. Application Data
(60) Provisional application No. 63/218,589, filed on Jul. 6, 2021.

(51) Int. Cl. C09D 175/04; C08G 18/63; C09D 17/00

(52) U.S. Cl. CPC C09D 175/04; C08G 18/631; C08G 18/638; C09D 17/002; C08G 2150/00

(57) ABSTRACT

The present invention is directed to curable film-forming compositions and coating kits comprising: (a) a polyisocyanate; (b) a dispersion comprising a polymer dispersed in an organic medium and prepared from an ethylenically unsaturated monomer having functional groups that are reactive with the polyisocyanate (a); and optionally (c) an adhesion promoter. The organic medium comprises a diluent having functional groups that are reactive with the polyisocyanate (a), the diluent comprising at least one of castor oil, a dimerized fatty acid diol, a hydroxyl functional branched polyolefin oil, a cashew nutshell liquid (CNSL)-based diol, a polycaprolactone-based polyol, and an alkoxylated polyol comprising a hydroxyl group. The curable film-forming composition has a solids content of at least 45 percent by weight, and demonstrates a viscosity of at most 100 centipoise (100 mPas). The present invention is also drawn to coated articles and vehicle components comprising the film-forming composition.

### FIELD OF THE INVENTION

The present invention relates to curable film-forming compositions useful as primer-sealers in vehicular refinish coating and OEM end-of-line repair settings.

### BACKGROUND OF THE INVENTION

Polymeric materials, such as thermoplastic polyolefin (TPO) and reaction injected molding urethane (RIM), are useful in many applications such as automobile parts and accessories, containers, household appliances and other commercial items. Such polymeric materials are often used as substrates with organic coating compositions applied for aesthetic purposes or to protect them from degradation when exposed to atmospheric weathering conditions such as sunlight, moisture, heat and cold. To achieve longer lasting and more durable parts, it is important for the coatings to be firmly adhered to the surface of the article.

Polymeric substrates made from a variety of thermoplastic and thermosetting materials, and metal substrates that are often used in conjunction with them on vehicles, have widely varying surface properties including surface tension, roughness and flexibility, which make strong adhesion of organic coatings to diverse types of substrates difficult, particularly after aging or environmental exposure of coated polymeric materials. To facilitate adhesion of organic coatings to polymeric substrates for example, the substrate can be pretreated using an adhesion promoter layer or tie coat, e.g., a thin coating layer about 0.25 mils (6.35 microns) thick, or by flame or corona pretreatment.

Typically, adhesion promoter layers used on TPO surfaces contain chlorinated polyolefins. Liquid adhesion promoting coating compositions containing polyolefin diols or a blend of a saturated polyhydroxylated polydiene polymer and a chlorinated polyolefin have also been developed, but often have high VOC (volatile organic compound) content, such as greater than 5 lb/gallon.

Chlorinated polyolefin (CPO) resins in particular are historically difficult resins to introduce into a coating formulation. They generally require non-polar solvents like xylene, toluene, and aromatic blends at relatively low solids (15-35%) in order to be stable and compatible with other component resins, pigments and additives.

While these known adhesion promoting compositions are generally acceptable for commercial applications, they tend to either have good adhesion to polymeric substrates with poor to moderate fuel resistance; or good adhesion and good fuel resistance but only with a small variety of polymeric substrate types or only at high levels of chlorinated polyolefin, resulting in high VOC. It would be desirable to eliminate the drawbacks associated with such an adhesion promoter and provide compositions useful as primer-sealers for application direct to plastic and other substrates, in order to meet the new demands in automotive manufacturing such as elimination of coating layers and lower VOC regulations.

### SUMMARY OF THE INVENTION

The present invention is directed to curable film-forming compositions and coating kits, each comprising:
(a) a polyisocyanate; and
(b) a dispersion comprising a polymer dispersed in an organic medium and prepared from an ethylenically unsaturated monomer having functional groups that are reactive with the polyisocyanate (a); and optionally
(c) an adhesion promoter. The organic medium comprises a diluent having functional groups that are reactive with the polyisocyanate (a), the diluent comprising at least one of castor oil, a dimerized fatty acid diol, a hydroxyl functional branched polyolefin oil, a cashew nutshell liquid (CNSL)-based diol, a polycaprolactone-based polyol, and an alkoxylated polyol (diol, triol, and/or tetrol) comprising a hydroxyl group, wherein the polyol contains 2 to 6 carbon atoms prior to alkoxylation. The curable film-forming composition or kit has a solids content of at least 45 percent by weight, or at least 50 percent by weight, or at least 60 percent by weight, and at most 72 percent by weight, or at most 70 percent by weight, based on the total weight of the curable film-forming composition or coating kit, and demonstrates a blended, application viscosity of at most 100 centipoise, or at most 75 centipoise, or at most 40 centipoise, when measured at 25° C. according to ASTM D4287-00 with a Brookfield CAP2000+ Viscometer at 900 seconds⁻¹ shear rate with a #4 Spindle.

The present invention is also drawn to coated articles, in particular, vehicle components, comprising:
(A) a substrate having at least one coatable surface, and
(B) the curable film-forming composition described above applied directly to at least one surface of the substrate. When the coated article is a vehicle component, the curable film-forming composition described above is applied to the substrate as a primer coating.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, means that at least a portion of the polymerizable and/or crosslinkable components that form the curable composition is polymerized and/or crosslinked through reactive functional groups, to the extent that a cured film prepared from the composition demonstrates no damage from at least 50 methylethyl ketone (MEK) double rubs according to ASTM D5402-19. The test method may be performed, for example, using the specified cheesecloth or another suitable cloth such as a Wypall X80 towel available from Kimberly Clark Corporation. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion, such as at least 10 percent, or at least 20 percent, of the reactive groups of the composition occurs, to form a polymerizate. The polymerizable composition can also be subjected to curing conditions such that a substantially complete cure is attained (such as at least 70 percent, or at least 80 percent, or at least 90 percent up to 100 percent, of the reactive groups react) and wherein further curing results in no significant further improvement in polymer properties, such as hardness.

The various examples of the present invention as presented herein are each understood to be non-limiting with respect to the scope of the invention.

The curable film-forming compositions and coating kits of the present invention comprise (a) a polyisocyanate. The polyisocyanate typically has free isocyanate groups (i.e., as opposed to blocked isocyanate groups) that are available for reaction with suitable co-reactants. The polyisocyanate can be aliphatic, aromatic, or a mixture thereof. Diisocyanates and higher polyisocyanates such as isocyanurates of diisocyanates can be used. Isocyanate prepolymers, for example reaction products of polyisocyanates with polyols also can be used. Mixtures of polyisocyanates can be used. In particular examples of the present invention, the polyisocyanate (a) comprises hexamethylene diisocyanate, isophorone diisocyanate (IPDI), and/or toluene diisocyanate. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

The polyisocyanate can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4-and 2,4,4-trimethyl hexamethylene diisocyanate, 1,6-hexamethylene diisocyanate, tetramethyl xylylene diisocyanate and 4,4′-diphenylmethylene diisocyanate.

The polyisocyanate (a) is typically present in the curable film-forming composition in an amount of at least 10, such as at least 20, or least 35, or at least 40, or at least 45 percent by weight, based on the total weight of resin solids in the curable film-forming composition. The polyisocyanate (a) may be present in the curable film-forming composition of the present invention in an amount of at most 90, such as at most 80, or at most 70 percent by weight, based on the total weight of resin solids in the curable film-forming composition.

Thus, the polyisocyanate may be present in the curable film-forming composition in an amount, for example, of 10 to 90 percent by weight, or 10 to 80 percent by weight, or 10 to 70 percent by weight, or 20 to 90 percent by weight, or 20 to 80 percent by weight, or 20 to 70 percent by weight, or 35 to 90 percent by weight, or 35 to 80 percent by weight, or 35 to 70 percent by weight, or 40 to 90 percent by weight, or 40 to 80 percent by weight, or 40 to 70 percent by weight, or 45 to 90 percent by weight, or 45 to 80 percent by weight, or 45 to 70 percent by weight.

As used herein “based on the total weight of resin solids” means that the amount of the component added during the formation of the composition is based upon the total weight of the non-volatile resins of the film forming materials, including cross-linkers, reactive diluents, adhesion promoters, and polymers present during the formation of the composition, but not including any water, volatile organic solvent, or any additive solids such as hindered amine stabilizers, photoinitiators, pigments including extender pigments and fillers, flow modifiers, catalysts, and UV light absorbers, unless otherwise indicated. The phrases “based on the total solid weight” and “based on the total weight of solids” (used interchangeably) of the composition means that the amount of the component added during the formation of the composition is based upon the total weight of the solids (non-volatiles) of the film forming materials, including cross-linkers, reactive diluents, adhesion promoters, and polymers, pigments including extender pigments and fillers, additive solids such as hindered amine stabilizers, photoinitiators, flow modifiers, catalysts, and UV light absorbers present during the formation of the composition, but not including any water or volatile organic solvent, unless otherwise indicated.

The curable film-forming compositions and coating kits of the present invention further comprise (b) a dispersion comprising a polymer dispersed in an organic medium and prepared from an ethylenically unsaturated monomer having functional groups that are reactive with the polyisocyanate (a). Often the dispersion is a non-aqueous dispersion. A “non-aqueous dispersion” as used herein is one in which 75% or greater, such as 90% or greater, or 95% or greater of the continuous medium is non-aqueous, typically organic. Accordingly, a non-aqueous dispersion can still comprise some level of aqueous material, such as water. The non-aqueous dispersion comprises the polymer mentioned above, which is a dispersion polymerization reaction product of: (i) a monomer mixture comprising the ethylenically unsaturated monomer having functional groups that are reactive with the polyisocyanate (a), and (ii) a polymeric stabilizer. As discussed further below, the monomer mixture (i) may further comprise a metal-containing ethylenically unsaturated monomer.

It will be appreciated by those skilled in the art that the non-aqueous dispersions used in the curable film-forming compositions of the present invention are distinct from latex, which are aqueous dispersions. The present non-aqueous dispersions are also distinct from solution polymers, in that the non-aqueous dispersions have a dispersed phase that is different from the continuous phase, while a solution polymer has a single, homogeneous phase.

The non-aqueous dispersions used in the curable film-forming compositions of the present invention do not form homogeneous solutions. They are characterized by discrete particles that are dispersed in a separate, continuous phase, referred to above as microparticles. The present non-aqueous dispersions may appear translucent or opaque, as is characteristic of dispersions.

The dispersion polymerization reaction product is prepared from (i) a monomer mixture comprising the ethylenically unsaturated monomer having functional groups that are reactive with the polyisocyanate (a); and (ii) a polymeric stabilizer. These monomers are sometimes referred to herein as the “core monomers”, as distinguished from the monomers used in the polymeric stabilizer or any seed polymer. Suitable core monomers may or may not be reactive with the polyisocyanate, provided at least one monomer in the monomer mixture is reactive with the polyisocyanate. Examples include methyl (meth)acrylate, ethyl(meth) acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl(meth) acrylate, styrene, diethylene glycol bis(allylcarbonate), alpha-methylstyrene, lauryl (meth)acrylate, stearyl(meth) acrylate, itaconic acid and its esters, and the like. In a particular example of the present invention the monomer mixture (i) comprises methyl (meth)acrylate and hydroxyethyl (meth)acrylate.

In certain examples of the present invention, the monomer mixture (i) further comprises a metal-containing ethylenically unsaturated monomer. The metal-containing ethylenically unsaturated monomer may be selected from at least one of dibutyltin maleate, dibutyltin diacrylate, dibutyltin monoacrylate, and zinc (meth)acrylate. THERM-CHEK 837 is an example of a dibutyl tin maleate ester commercially available from Valtris Specialty Chemicals.

Coreactive monomers, i.e., monomers reactive with each other, will result in branching, or internal crosslinking, of the core during the polymerization process in the making of the dispersed polymeric particles. Alternatively, the internal crosslinking can be introduced by using a polyfunctional ethylenically unsaturated monomer, such as hexanediol diacrylate, ethylene glycol dimethacrylate, trimethylol propane triacrylate, diethylene glycol bis(allylcarbonate), divinylbenzene, or other suitable poly(meth)acrylate, in the core monomer composition.

The polymeric stabilizer may comprise an aliphatic polyester and/or an aliphatic poly(meth)acrylate. The aliphatic poly(meth)acrylate typically comprises 50 percent by weight or greater (meth)acrylic monomers. In certain example of the present invention, the polymeric stabilizer (ii) comprises an aliphatic poly(meth)acrylate (“acrylic stabilizer”), in turn comprising 75 weight % or greater, such as 90 weight % or greater or 95 weight % or greater of acrylic monomers. In certain examples the stabilizer comprises 100 weight % acrylic monomers. In certain examples, the stabilizer comprises polar acrylic monomers, such as hydroxyl functional acrylic monomers, in an amount of 30 weight % or less, such as 20 weight % or less, 15 weight % or less or 10 weight % or less. The term “polar” as used herein refers to acrylic monomers or compounds that have a solubility parameter (van Krevelen) at 298 K of 19 MPa or more. In other examples, the stabilizer comprises nonpolar acrylic monomers, such as 2-ethyl hexyl acrylate, which can be in amounts of 5 weight % or greater, such as 10 weight % or greater. The term “non-polar” describes substances that have a solubility parameter (van Krevelen) at 298 K lower than 19 MPa. Weight %, as used in the context of weight % of monomers, refers to the weight % of monomers used in the formation of the stabilizer, and does not include other ingredients, such as initiators, chain transfer agents, additives and the like, used to form the stabilizer. As used herein, the term (meth)acrylic refers generally to acrylics, methacrylics, styrene and any derivatives of any of these.

Suitable monomers for the preparation of an acrylic stabilizer include but are not limited to methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, lauryl (meth)acrylate, stearyl (meth)acrylate, itaconic acid and its esters, allyl (meth)acrylate, ethylene glycol dimethacrylate, hexanediol diacrylate and the like. As noted above, 50 weight % or greater of the monomers used in the formation of the acrylic stabilizer are acrylic.

In certain examples, the acrylic stabilizer is nonlinear. As used herein, the term “nonlinear” means that there is at least one branch point along the backbone of the polymer. In some cases, there may be multiple branch points (i.e., “hyperbranched”), and in some examples, the branches can form connections between polymer chains (i.e. internal crosslinks). It will be appreciated that polymer branching can be quantified using the Mark-Houwink parameter. In certain examples, the Mark-Houwink parameter of the present nonlinear acrylic stabilizers as measured by triple detection GPC is 0.2-0.7, such as 0.3-0.6. The branching can be introduced, for example, by using a polyfunctional ethylenically unsaturated monomer in the formation of the acrylic stabilizer. A polyfunctional ethylenically unsaturated monomer is a monomer that has two or more ethylenically unsaturated functional groups within the same monomer molecule, such as allyl (meth) acrylate, ethylene glycol dimethacrylate, or hexanediol diacrylate. Alternatively, the branching can be introduced by using two or more coreactive monomers, such as glycidyl methacrylate and acrylic acid, in the formation of the acrylic stabilizer.

In certain examples, the acrylic stabilizer contains ethylenic unsaturation. This ethylenic unsaturation can be introduced, for example, by using a polyfunctional ethylenically unsaturated monomer in the formation of the acrylic stabilizer, wherein the two (or more) ethylenically unsaturated functional groups within the monomer molecule have different reactivities towards the other (meth)acrylate monomers used to form the stabilizer. Each polyfunctional ethylenically unsaturated monomer molecule may react completely with other (meth)acrylate monomers to form branch points/crosslinks, or it may react incompletely and retain at least one of its ethylenically unsaturated functional groups. This unsaturation is then available to react during the preparation of the non-aqueous dispersion, allowing the acrylic stabilizer to be covalently bonded to the dispersed phase polymer. A suitable monomer for this purpose can be, for example, allyl (meth)acrylate. Alternatively, the unsaturation can be introduced by reacting the acrylic polymer with a compound that comprises both ethylenic unsaturation and another functional group that can react with a functional group on the acrylic polymer. For example, the acrylic polymer can have oxirane groups, and the compound can comprise a (meth)acrylate group and an acid group, so that the acid group on the compound would react with the oxirane group on the acrylic polymer.

The reaction conditions can be controlled so that polymerization of the (meth)acrylate groups on the compound would be prevented; suitable controls would be a reduced reaction temperature such as below 110° C., the presence of a free radical inhibitor such as para-methoxyphenol, and the use of an oxygen-rich atmosphere. Under controlled conditions such as these, the (meth)acrylate group on the compound would be retained, and this unsaturation would then be available to react during the preparation of the non-aqueous dispersion, allowing the acrylic stabilizer to be covalently bonded to the dispersed phase polymer. A suitable example for the introduction of unsaturation to the acrylic stabilizer would be the reaction of an acrylic polymer that comprises glycidyl methacrylate, such as 3-15 weight % glycidyl methacrylate, with methacrylic acid, where the ratio of acrylic polymer to methacrylic acid is from about 200:1 to about 33:1.

Generally, the acrylic stabilizer is formed by solution polymerization of the (meth)acrylate monomers by a standard radical polymerization method known to those skilled in the art. For example, the (meth)acrylate monomers can be added over a period of time to a suitable solvent at an elevated temperature, such as at the reflux temperature of the solvent. A radical initiator, such as a peroxide initiator, is added to the reaction mixture over approximately the same time period. The initiator is chosen so that it will induce radical polymerization of the monomers at the selected reaction temperature. Suitable free radical initiators include peroxy initiators such as benzoyl peroxide, lauroyl peroxide, or tert-butylperoxy-2-ethyl-hexanoate (tert-butylperoctoate) and azo initiators such as 2,2′-azobis (2,4-dimethylpentane nitrile) or 2,2′-azobis (2-methylbutane nitrile). After the monomers and initiator have been added to the reaction mixture, the mixture may be held at the reaction temperature for an extended period of time, during which additional initiator may be added to ensure complete conversion of the monomers. Progress of the reaction may be monitored by solids measurement, or by gas chromatography.

In certain examples, the acrylic stabilizer can be prepared in a continuous reactor. For example, (meth) acrylate monomers and a radical initiator, such as a peroxide initiator, can be fed continuously through a continuous reactor with a 1 to 20 minute residence time at 150-260° C. The (meth)acrylate monomers used herein could be polar, non-polar, or a mixture of both types.

In certain examples, the molar ratio of acrylate to methacrylate in the acrylic stabilizer can be about 2:1. The initiator level may range from 0.5 to 2.0 weight %, such as 1.0 to 1.5 weight % based on the total weight of the monomers.

The acrylic stabilizer can have a weight average molecular weight (“M_{w}”, expressed in Da throughout the specification) as measured by gel permeation chromatography relative to linear polystyrene standards of at least 10,000, or at least 20,000, or at least 30,000; and at most 1,000,000, or at most 80,000, or at most 60,000. For example, the acrylic stabilizer can have a weight average molecular weight (“M_{w}”) as measured by gel permeation chromatography relative to linear polystyrene standards of 10,000 to 1,000,000, or 10,000 to 80,000, or 10,000 to 60,000, or 20,000 to 1,000,000, or 20,000 to 80,000, or 20,000 to 60,000, or 30,000 to 1,000,000, or 30,000 to 80,000, or 30,000 to 60,000. The stabilizer may comprise ethylenic unsaturation, as detected by 13C NMR spectroscopy. The stabilizer can contain functional groups, such as hydroxyl groups, carboxylic acid groups, and/or epoxy groups.

The polymeric stabilizer (ii) may additionally or alternatively comprise an aliphatic polyester. A suitable polyester would be, for example, poly-12-hydroxy stearic acid. The polyester is typically prepared from 12-hydroxystearic acid and/or ricinoleic acid.

The aliphatic polyester can be used to prepare a polyester stabilizer. The polyester stabilizer may comprise two segments, one of which comprises the aliphatic polyester described above, and one of which is of a different polarity from the polyester. The first of these is sometimes referred to herein as the “aliphatic polyester component” and the second as the “stabilizer component”. Suitable stabilizer components are known and some examples have been described in U.S. Pat. No. 4,147,688, Column 5, Line 1-Column 6, Line 44.

In one example of the present invention, the aliphatic polyester can comprise poly-12-hydroxy stearic acid having a number average molecular weight of about 300 to 3,600 Da and comprising both acid and hydroxyl functionality. The poly-12-hydroxystearic acid may then be reacted with a compound that comprises (meth)acrylate functionality as well as a second type of functional group that can react with functional groups on the poly-12-hydroxy stearic acid. A suitable compound would be, for example, glycidyl (meth)acrylate. The reaction product of the poly-12-hydroxy stearic acid and glycidyl (meth)acrylate can be further reacted with an ethylenically unsaturated monomer having a different polarity from poly-12-hydroxy stearic acid by a standard free-radical polymerization reaction to yield the polyester stabilizer. Suitable ethylenically unsaturated monomers include but are not limited to (meth)acrylic acid, methyl (meth)acrylate, ethyl (meth)acrylate, n-butyl (meth)acrylate, isobutyl (meth)acrylate, 2-ethylhexyl (meth)acrylate, isobornyl (meth)acrylate, 2-hydroxyethyl (meth)acrylate, 2-hydroxypropyl (meth)acrylate, (meth)acrylic acid, glycidyl (meth)acrylate, lauryl (meth)acrylate, stearyl (meth)acrylate, itaconic acid and its esters, and the like. In one example, the ethylenically unsaturated monomer comprises methyl methacrylate, glycidyl methacrylate, and methacrylic acid. It will be appreciated that standard free-radical polymerization techniques are well-known to those skilled in the art. The polyester stabilizer may comprise at least 20 percent by weight, or at least 25 percent by weight, or at least 30 percent by weight, or at least 33 percent by weight, and at most 65 percent by weight, or at most 60 percent by weight, or at most 55 percent by weight, or at most 53 percent by weight polyester component, based on the total weight of the components of the polyester stabilizer. Thus, the polyester stabilizer may comprise 20 to 65 percent by weight polyester component, or 20 to 60 percent by weight, or 20 to 55 percent by weight, or 20 to 53 percent by weight, or 25 to 65 percent by weight, or 25 to 60 percent by weight, or 25 to 55 percent by weight, or 25 to 53 percent by weight, 30 to 65 percent by weight, or 30 to 60 percent by weight, or 30 to 55 percent by weight, or 30 to 53 percent by weight, 33 to 65 percent by weight, or 33 to 60 percent by weight, or 33 to 55 percent by weight, or 33 to 53 percent by weight, based on the total weight of the components of the polyester stabilizer. A particularly suitable example of a polyester stabilizer is demonstrated in Examples 1 and 2 of U.S. Pat. No. 9,752,025.

The polyester stabilizer can be used to prepare a particulate seed polymer. The seed polymer generally comprises the polyester stabilizer described above and dispersed polymer. The seed polymer can be prepared by dissolving the polyester stabilizer in a suitable solvent or mixture of solvents, and the monomer(s) used to form the seed polymer (“seed monomer(s)”) may be added to the solution at an elevated temperature over a period of time, during which a radical initiator may also be added to the mixture. The dispersed polymer can be covalently bonded, or grafted, to the polyester stabilizer. A seed polymer can be prepared, for example, from a polyester stabilizer and an ethylenically unsaturated monomer such as a (meth) acrylate monomer. The polymer formed from the ethylenically unsaturated monomer should be insoluble in the continuous phase in order to provide a stable dispersion. It will be appreciated by those skilled in the art that, if the polyester stabilizer comprises ethylenic unsaturation, then in addition to the polymerization of the seed monomer(s) with other seed monomer(s), at least some of the polymerizable double bonds of the stabilizer will react with some of the seed monomer(s) under these conditions. Through this process, the seed polymer will become grafted, that is, covalently bonded, to the polyester stabilizer. A suitable seed polymer can be prepared from a polyester stabilizer comprising poly-12-hydroxystearic acid in 60% ISOPAR K (a hydrocarbon solvent commercially available from ExxonMobil Chemical) and 40% butyl acetate and methyl methacrylate.

The seed polymer as described above can be prepared as a stable dispersion. For example, the seed polymer can be prepared and stored for use at a later time. Alternatively, it can be used immediately in the preparation of the non-aqueous dispersion.

The non-aqueous dispersions may comprise components with functionality such as hydroxyl functionality. For example, the hydroxyl functionality can come from the core monomers and/or the polymeric stabilizer. The theoretical hydroxyl value of the non-aqueous dispersion, which may be measured, for example, using ASTM E222-10, can be at least 40, or at least 50, or at least 175, and at most 300, or at most 275, or at most 250, such as from 40 to 300, or from 40 to 275, or from 40 to 250, or from 50 to 300, or from 50 to 275, or from 50 to 250, or from 175 to 300, or from 175 to 275, or from 175 to 250, based on the total weight of the non-aqueous dispersion. The non-aqueous dispersions may, but does not usually, comprise epoxy functionality. In such examples the epoxy equivalent weight (g/eq) may be 400 to 30,000, such as from 700 to 15,000. In certain examples of the present invention the non-aqueous dispersions may comprise both hydroxyl and epoxy functionality. In certain examples, the non-aqueous dispersions may comprise acid functionality. In these examples, the theoretical acid value may be from 0.1 to 20, such as from 5 to 15, and may be measured, for example, using ASTM D974-14e2.

The polymers within the non-aqueous dispersions may be internally crosslinked or uncrosslinked. Crosslinking of the polymers can be achieved, for example, by including two or more coreactive monomers, or a polyfunctional ethylenically unsaturated monomer with the “core” monomers during polymerization, as described above for suitable “core” monomers. The two or more co-reactive monomers, or polyfunctional ethylenically unsaturated monomer, can be present in amounts of 0.1 to 20% by weight based on the total weight of monomers used in preparing the non-aqueous dispersion, such as from 1 to 10% by weight.

The core monomers of the monomer mixture (i) are polymerized in the presence of the polymeric stabilizer (and seed polymer, if present) in an organic medium as described in the Examples below, to form a non-aqueous dispersion that may be used in the curable film-forming composition of the present invention. The organic medium comprises a diluent having functional groups that are reactive with the polyisocyanate (a) in the curable film-forming composition. The reactive diluent usually comprises at least one of castor oil; a dimerized fatty acid diol; a hydroxyl functional branched polyolefin oil; a cashew nutshell liquid (CNSL)-based diol; a polycaprolactone-based polyol; an alkoxylated diol comprising a hydroxyl group wherein the diol contains 2 to 6 carbon atoms prior to alkoxylation; an alkoxylated triol comprising a hydroxyl group, wherein the triol contains 2 to 6 carbon atoms prior to alkoxylation, and an alkoxylated tetrol comprising a hydroxyl group, wherein the tetrol contains 2 to 6 carbon atoms prior to alkoxylation. The hydroxyl group in any of the alkoxylated polyols may be primary or secondary. Examples of commercially available dimerized fatty acid diols include PRIPOL 2030, commercially available from Croda International Plc. Exemplary cashew nutshell liquid (CNSL)-based diols are available from Cardolite Corporation. Examples of commercially available hydroxyl functional branched polyolefin oils include VYBAR H-6164 and VYBAR H-6175, available from Baker Hughes, Inc. The polycaprolactone-based polyols may comprise diols, triols or tetrols terminated with primary hydroxyl groups. Commercially available polycaprolactone-based polyols include those sold under the trade name Capa™ from Perstorp Group, such as, for example, Capa 2054, Capa 2077A, Capa 2085, Capa 2205, Capa 3031, Capa 3050, Capa 3091 and Capa 4101. Diols that may be alkoxylated include 1,6-hexanediol, 1,3-propanediol. 2,2-dimethyl-1,3-propanediol, dihydroxy diethyl ether, and glycols such as ethylene glycol, propylene glycol, and butylene glycol. Triols that may be alkoxylated include trimethylol propane and glycerol. Tetrols that may be alkoxylated include erythritol, pentaerythritol, and sorbitan. An example of a suitable alkoxylated trifunctional polyol with secondary hydroxyl groups is POLYOL R3530, available from Perstorp. In certain examples of the present invention, the organic medium further comprises a mixture of isoparaffins having 8 to 12 carbon atoms, such as the ISOPAR line of products available from ExxonMobil Chemical.

In some examples the non-aqueous dispersion may be substantially free, may be essentially free and/or may be completely free of VOC (Volatile Organic Compounds), particularly non-polymerizable VOC. The term “substantially free” as used in this context means the continuous phase and/or dispersions contain less than 10%, “essentially free” means less than 5%, and “completely free” means less than 1% of VOC by weight of the continuous phase. The terms “volatile organic compound” and “VOC” are understood to have the definition used by the United States Environmental Protection Agency; i.e., any organic compound having an initial boiling point less than or equal to 250° C. measured at a standard atmospheric pressure of 101.3 kPa. With respect to the non-aqueous dispersion, “volatile organic compound” or “VOC” typically means any organic compound that volatilizes before, during or after polymerization of the monomer mixture (i). The non-aqueous dispersion typically has a resin solids content of at least 70 percent by weight, or at least 75 percent by weight, or at least 80 percent by weight, and at most 100 percent by weight, or at most 90 percent by weight, based on the total weight of the non-aqueous dispersion. Exemplary ranges of resin solids content include 70 to 100, or 70 to 90, or 75 to 100, or 75 to 90, or 80 to 100, or 80 to 90 percent by weight.

The dispersion (b) is typically present in the curable film-forming composition of the present invention in an amount of at least 5, such as at least 10, or least 20, percent by weight, based on the total weight of resin solids (i.e., the total weight of (a), (b), and (c)) in the curable film-forming composition. The dispersion (b) may be present in the curable film-forming composition of the present invention in an amount of at most 40, such as at most 35, or at most 30 percent by weight, based on the total weight of resin solids in the curable film-forming composition. Thus, the dispersion (b) may be present in the curable film-forming composition in an amount, for example, of 5 to 40 percent by weight, or 5 to 35 percent by weight, or 5 to 30 percent by weight, or 10 to 40 percent by weight, or 10 to 35 percent by weight, or 10 to 30 percent by weight, or 20 to 40 percent by weight, or 20 to 35 percent by weight, or 20 to 30 percent by weight.

The curable film-forming compositions and coating kits of the present invention may further comprise (c) an adhesion promoter. Adhesion promoters are more often suitable in compositions for use over non-metallic substrates. The adhesion promoter (c) typically comprises a chlorinated polyolefin and/or a non-chlorinated, linear polyolefin polymer. Examples of suitable chlorinated polyolefins include chlorinated polyethylene, chlorinated polypropylene, chlorinated polybutene, and mixtures thereof. Chlorinated polyolefins suitable for use in the present invention usually have a calculated chlorine content between 15% by weight and 60% by weight, based on the total solid weight of the final chlorinated polyolefin, and more often between 18% by weight and 23% by weight. The chlorinated polyolefin usually has a weight average molecular weight between 5000 and 200,000, more often, between 10,000 and 40,000. The chlorinated polyolefin may be solid, in powder or pelletized form, or in solution. Commercially available chlorinated polyolefins include those sold under the SUPERCHLON line of products available from Nippon Paper Group, those sold under the HARDLEN line of products available from TOYOBO, and CPO-343-1, available from Eastman Chemical Company of Kingsport, Tenn., USA. Other suitable chlorinated polyolefins are described in U.S. Pat. Nos. 4,997,882; 5,319,032; and 5,397,602.

The non-chlorinated, linear polyolefin polymer may be prepared from a reaction mixture comprising 0.5 to 10 percent by weight ethylenically unsaturated acid or anhydride based on the total weight of monomers in the reaction mixture, such that the resulting linear polyolefin polymer comprises 0.5 to 10 percent by weight residues of the ethylenically unsaturated anhydride or acid, based on the total weight of the linear polyolefin polymer. For example, the residues may be present in the linear polyolefin polymer in an amount of at least 0.5 percent by weight, or at least 1 percent by weight, or at least 2 percent by weight; and in an amount of at most 10 percent by weight, or at most 7 percent by weight, or at most 5 percent by weight. Thus, the residues may be present in the linear polyolefin polymer in an amount of 0.5 to 10 percent by weight, or 0.5 to 7 percent by weight, or 0.5 to 5 percent by weight, or 1 to 10 percent by weight, or 1 to 7 percent by weight, or 1 to 5 percent by weight, or 2 to 10 percent by weight, or 2 to 7 percent by weight, or 2 to 5 percent by weight. By “residue” is meant a moiety that is present in a reaction product (such as a polymer), formed by a particular reactant (such as a monomer) during reaction (e.g., polymerization). Suitable ethylenically unsaturated anhydrides and acids may include one or more of maleic anhydride, monocarboxylic acids such as acrylic acid, methacrylic acid, crotonic acid; dicarboxylic acids such as itaconic acid, maleic acid and fumaric acid. The reaction mixture used to prepare the linear polyolefin polymer may further comprise ethylene and/or propylene. The polyolefin polymers may comprise one or more of polyethylene, polypropylene, polymethylpentene, polybutene-1, polyisobutylene, and the like. In a particular example of the present invention, the linear polyolefin polymers often comprise polyethylene, or more often polypropylene, and at least 0.5 percent by weight, or at least 1 percent by weight, or at least 2 percent by weight, and up to 10 percent by weight, such as up to 7 percent by weight, or up to 5 percent by weight, or up to 4 percent by weight, or up to 3 percent by weight maleic anhydride residues, based on the total weight of the linear polyolefin. Thus, the linear polyolefin polymers often comprise polyethylene, or more often polypropylene, and 0.5 to 10 percent by weight, or 0.5 to 7 percent by weight, or 0.5 to 5 percent by weight, or 0.5 to 4 percent by weight, or 0.5 to 3 percent by weight, or 1 to 10 percent by weight, or 1 to 7 percent by weight, or 1 to 5 percent by weight, or 1 to 4 percent by weight, or 1 to 3 percent by weight, or 2 to 10 percent by weight, or 2 to 7 percent by weight, or 2 to 5 percent by weight, or 2 to 4 percent by weight, or 2 to 3 percent by weight maleic anhydride residues, based on the total weight of the linear polyolefin. Examples include the linear polyolefins TOYO-TAC and PMA-LE, available from TOYOBO CO., LTD.

The linear polyolefin polymers may be prepared so as to have additional functional groups comprising ester and/or urethane groups, and/or additional reactive groups comprising hydroxyl, epoxy, and/or siloxane groups. The reactive groups on these polyolefins may then be further reacted with a polyfunctional material, a lactone, or a lactide to yield a non-chlorinated, reactive polyolefin having functional groups comprising ester and/or urethane groups, and/or reactive groups comprising hydroxyl, epoxy, and/or siloxane groups.

Examples of polyfunctional materials include diepoxides or higher polyepoxides. Use of a diepoxide as a difunctional material allows for bridging between polyolefins that contain acid functional groups. Other polyfunctional materials are epoxy functional alkoxysilanes such as SILQUEST® A-187, commercially available from Momentive Performance Materials; and isocyanate functional alkoxysilanes, such as SILQUEST® A-link 35, an isocyanatopropyl trimethoxy silane, and SILQUEST® A-link 25, an isocyanatopropyl triethoxy silane, both commercially available from Momentive Performance Materials.

In certain examples of the present invention, the linear polyolefin polymer is further reacted with a polyepoxide and a monohydric alcohol. Examples of suitable monohydric alcohols include n-propanol, isopropanol, n-butanol, and/or isobutanol.

In other examples of the present invention, the reaction mixture used to prepare the linear polyolefin polymer further comprises an ethylenically unsaturated monomer comprising at least one (meth)acrylic monomer, including any of those known in the art. The terms “(meth)acrylic”, “(meth)acrylate” and the like are meant to encompass acrylate and/or methacrylate molecular structures where they exist. Examples of suitable polyolefin polymers prepared in this manner are commercially available as AUROREN, from Nippon Paper.

Each of the linear polyolefin polymers described above may be used individually or in any combination with each other in the film-forming composition. The adhesion promoter (c) is different from any of the constituents of the organic medium of the non-aqueous dispersion.

The adhesion promoter (c) may be present in the film-forming composition in an amount of at least 5 percent by weight, or at least 10 percent by weight, or at least 15 percent by weight, and up to 40 percent by weight, such as up to 30 percent by weight, or up to 20 percent by weight, based on the total weight of resin solids in the film-forming composition. Thus, the adhesion promoter (c) may be present in the film-forming composition in an amount of 5 to 40 percent by weight, or 5 to 30 percent by weight, or 5 to 20 percent by weight, or 10 to 40 percent by weight, or 10 to 30 percent by weight, or 10 to 20 percent by weight, or 15 to 40 percent by weight, or 15 to 30 percent by weight, or 15 to 20 percent by weight.

The curable film-forming compositions and coating kits of the present invention may further comprise a pigment. The pigment, or colorant, can be added to the coating in any suitable form, such as discrete particles, dispersions, solutions and/or flakes. A colorant can be organic or inorganic and can be agglomerated or non-agglomerated. Colorants can be incorporated into the coatings by grinding or simple mixing. Colorants can be incorporated by grinding into the coating by use of a grind vehicle, the use of which will be familiar to one skilled in the art. A single colorant or a mixture of two or more colorants can be used in the coatings of the present invention.

Suitable pigments include any of those known in the art of surface coatings. Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. Particular examples of pigments for primer compositions include carbon black, titanium dioxide, barium sulfate, and the like.

The curable film-forming compositions and coating kits of the present invention may contain adjunct ingredients conventionally used in coating compositions. Optional ingredients such as, for example, catalysts, plasticizers, surfactants, thixotropic agents and/or other rheology control agents, matting agents, organic cosolvents, flow controllers, anti-oxidants, UV light absorbers (such as in a topcoat composition), corrosion inhibitors, and similar additives conventional in the art may be included in the compositions. Suitable catalysts may include tin compounds such as triphenyl tin hydroxide, butyl stannoic acid, dioctyltin oxide, dibutyltin dilaurate, dibutyltin diacetate, and dibutyltin oxide. The adjunct ingredients are typically present at up to about 40% by weight based on the total weight of resin solids.

As noted above, the curable film-forming compositions and coating kits of the present invention typically demonstrate a solids content of at least 45 percent by weight, or at least 50 percent by weight, or at least 60 percent by weight, and at most 72 percent by weight, or at most 70 percent by weight, based on the total weight of the curable film-forming composition or coating kit. Exemplary ranges include 45 to 72, or 45 to 70, or 50 to 72, or 50 to 70, or 60 to 72, or 60 to 70 percent by weight.

As noted above, the present invention is also drawn to coating kits. It is often not practical to store ambient-cure coatings as a one-package composition, but rather they must be stored as multi-package coatings to prevent the reactive constituents from curing prior to use. The term “multi-package coatings” refers to coatings in which various constituents are maintained separately until just prior to application. The coating kits of the present invention are usually multi-package coatings comprising multiple, separate components, such as wherein a first component comprises the polyisocyanate (a), and a second component comprises the dispersion (b) and the adhesion promoter (c).

The curable film-forming compositions and coating kits of the present invention typically demonstrate a blended, application viscosity upon formulation of at most 100 centipoise, or at most 75 centipoise, or at most 40 centipoise, when measured at 25° C. according to ASTM D4287-00 with a Brookfield CAP2000+ Viscometer at 900 seconds⁻¹ shear rate with a #4 Spindle. By “blended, application viscosity” is meant that the viscosity of the composition is measured after all the components are mixed together, immediately prior to application to a substrate, typically within 10 minutes of mixing.

The present invention is further drawn to a coated article comprising a substrate and the curable film-forming composition described above applied to at least one surface of the substrate. The curable film-forming composition may be applied directly to a surface of the substrate, or on top of intervening layers as mentioned below. The curable film-forming composition may serve as a primer, sealer, combination primer-sealer (which serves the purposes of both a primer and a sealer), basecoat (e.g., decorative coating layer containing a colorant), and/or direct gloss topcoat, imparting a decorative and/or protective finish to the substrate.

Suitable substrates may include metallic and/or non-metallic materials. Non-metallic substrates include polymeric, elastomeric, plastic, polyester, polyolefin, polyamide, cellulosic, polystyrene, polyacrylic, poly (ethylene naphthalate), polypropylene, polyethylene, nylon, EVOH, poly (lactic acid), other “green” polymeric substrates, poly (ethylene terephthalate) (“PET”), polycarbonate, polycarbonate acrylonitrile butadiene styrene (“PC/ABS”), polyamide, polymer composites and the like. Car parts typically formed from thermoplastic and thermoset materials include bumpers and trim.

The metal substrates used in the present invention include ferrous metals, non-ferrous metals and combinations thereof. Suitable ferrous metals include iron, steel, and alloys thereof. Non-limiting examples of useful steel materials include cold rolled steel, pickled steel, steel surface-treated with any of zinc metal, zinc compounds and zinc alloys (including electrogalvanized steel, hot-dipped galvanized steel, GALVANNEAL steel, and steel plated with zinc alloy) and/or zinc-iron alloys. Also, aluminum, aluminum alloys, zinc-aluminum alloys such as GALFAN, GALVALUME, aluminum plated steel and aluminum alloy plated steel substrates may be used, as well as magnesium metal, titanium metal, and alloys thereof. Steel substrates (such as cold rolled steel or any of the steel substrates listed above) coated with a weldable, zinc-rich or iron phosphide-rich organic coating are also suitable for use in the present invention. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below.

The substrate may alternatively comprise more than one metal or metal alloy in that the substrate may be a combination of two or more metal substrates assembled together such as hot-dipped galvanized steel assembled with aluminum substrates. The substrate may alternatively comprise a composite material such as a fiberglass composite. The coated articles of the present invention can comprise at least two different substrates, which may include both metal and non-metal parts, to which the curable film-forming composition is applied with acceptable adhesion on each substrate.

The coated article may comprise part of a vehicle, prepared using one or more suitable substrates. “Vehicle” is used herein in its broadest sense and includes all types of vehicles, such as but not limited to airplanes, helicopters, cars, trucks, buses, vans, golf carts, motorcycles, bicycles, railroad cars, tanks and the like. It will be appreciated that the portion of the vehicle that is coated according to the present invention may vary depending on why the coating is being used.

The shape of the substrate can be in the form of a sheet, plate, bar, rod or any shape desired, but it is usually in the form of an automobile part, such as a body, door, fender, hood or bumper. The thickness of the substrate can vary as desired.

The coated article may alternatively comprise a component of a building, bridge, industrial protective structure, ship, railcar, railcar container, water tower, power line tower, tunnel, oil or gas industry structure, marine structure, aerospace structure, bridge support structure, pipeline, oil rig, storage tank, or wind turbine, again, prepared using one or more suitable substrates.

Metal substrates to be used may be bare substrates such that the curable film-forming composition is applied as a direct-to-metal (DTM) coating. By “bare” is meant a virgin substrate that has not been treated with (or has been stripped of) any pretreatment compositions such as conventional phosphating baths, heavy metal rinses, etc. Additionally, bare metal substrates being used in the present invention may be a cut edge of a substrate that is otherwise treated and/or coated over the rest of its surface. Alternatively, the substrates may undergo one or more treatment steps known in the art prior to the application of the curable film-forming composition.

Before depositing any coating compositions upon the surface of the substrate, it is common practice, though not necessary, to remove foreign matter or previously applied paints such as OEM coatings from the surface by thoroughly stripping, cleaning and degreasing the surface. When the substrate is not an existing vehicle part, such cleaning typically takes place after forming the substrate (stamping, welding, etc.) into an end-use shape. The surface of the substrate can be cleaned by physical or chemical means, or both, such as mechanically abrading the surface (e.g., sanding) or cleaning/degreasing with commercially available alkaline or acidic cleaning agents which are well known to those skilled in the art, such as sodium metasilicate and sodium hydroxide. Non-limiting examples of cleaning agents are CHEMKLEEN 163, an alkaline-based cleaner, and OneChoice SU4901 Clean and Scuff Sponge, both commercially available from PPG.

The coated articles of the present invention may further comprise at least one additional film-forming composition applied on top of the curable film-forming composition and/or as an intervening layer between the curable film-forming composition and the substrate(s). This may comprise an electrodeposited layer, a primer, a sealer, and/or one or more topcoats such as a basecoat (which typically contains a colorant), clearcoat, or direct gloss topcoat. The intervening layer does not comprise an adhesion promoter (“ad-pro”) layer as commonly used in the art. The curable film-forming compositions of the present invention eliminate the need for an ad-pro layer, as shown in the Examples below.

The purpose of applying a sealer over a repair area is to provide a smooth and consistent surface on top of which may be applied the repair topcoat layers. The sealer is expected to provide this smoothness with essentially no sanding, and the sealer is conventionally applied in one to two coats at a total dry film thickness around 25 microns. The sealer may be applied over a previously applied primer to hide the sand scratch marks produced when sanding the primer. Oftentimes, in the absence of a sealer, these sanding marks may be transmitted through to the basecoat and are visible as an optical defect in the repair part. A sealer may also be applied to a partial sand-through repair spot to negate the often variable surface energies created by the multiple exposed surfaces. These variable surface energies sometimes lead to optical defects visible in the basecoat layer (known as “ringing”). In this case, the sealer provides a consistent surface energy layer across the surface, on top of which the topcoat is applied. Because the sealer is applied prior to the repair topcoat and is generally not sanded, the “feather-out” area towards the edge of the repair where the contiguous sealer film blends into the original, unsanded area should be smooth enough to be topcoated without additional processing. It is further desirable for the sealer to dry and be processable within 10 to 15 minutes after application. By “processable” is meant “set to touch” as defined in any of the methods disclosed in ASTM D-5895-13.

A topcoat provides, inter alia, aesthetic properties such as color to the substrate, and may be a direct gloss topcoat or a composite coating system comprising a colored basecoat followed by a clear coat. Such coatings may comprise any known in the art of surface coatings and may comprise curable compositions.

Each coating composition may be applied by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

After application of a composition, a film is formed by driving solvent, i.e., organic solvent and water, out of the film by heating or by an air-drying period. Suitable drying conditions will depend on the particular composition and/or application, but in some instances a drying time of from about 5 to 30 minutes at a temperature of about room temperature to 60° C. will be sufficient. More than one coating layer of each composition may be applied if desired. Usually between coats, the previously applied coat is flashed; that is, exposed to ambient conditions for the desired amount of time.

The curable film-forming composition of the present invention applied to the substrate typically demonstrates a dry film thickness of at least 15 microns or at least 35 microns, or at least 50 microns, to at most 150 microns or at most 125 microns; exemplary ranges include 15 to 150 microns, or 15 to 125 microns, or 35 to 150 microns, or 35 to 125 microns, or 50 to 150 microns, or 50 to 125 microns. Dry film thicknesses may be measured 24 hours after application of the coating when cured at ambient temperatures, using a DUALSCOPE FMP40C with an FD13H probe, available from Fischer Technologies, Inc., according to manufacturer's directions.

Often, after curing the curable film-forming composition on the substrate, the coated article demonstrates an adhesion rating of 0 to 2 within seven days after application of the curable film-forming composition to the substrate, when subjected to ISO 2409, Third Edition published 2007 May 15, using a hand-held single blade cutting tool making cuts with 2 mm spacing. When at least two different substrates are coated, the coated article demonstrates an adhesion rating of 0 to 2 on each of the substrates within seven days after application of the curable film-forming composition to the substrates, when subjected to ISO 2409, Third Edition published 2007 May 15, using a hand-held single blade cutting tool making cuts with 2 mm spacing.

The coated articles of the present invention may be prepared by a method comprising:
(a) applying the curable film-forming composition described above directly (i.e., without an intervening layer) to at least a portion of at least one substrate as described above (such as at least two different substrates) to form at least one coated substrate; and
(b) subjecting the at least one coated substrate to a temperature of at least 0° C., or at least 10° C., or at least 20° C., and at most 60° C., or at most 40° C., or at most 30° C., such as 0 to 60° C., or 0 to 40° C., or 0 to 30° C., or 10 to 60° C., or 10 to 40° C., or 10 to 30° C., or 20 to 60° C., or 20 to 40° C., or 20 to 30° C., to cause curing of the curable film-forming composition. Each coated substrate typically demonstrates an adhesion rating of 0 to 2 within seven days after application of the curable film-forming composition to each substrate, when subjected to ISO 2409, Third Edition published 2007 May 15, using a hand-held single blade cutting tool making cuts with 2 mm spacing.

At least one additional film-forming composition as described above may be applied on top of at least a portion of the curable film-forming composition of the present invention.

The following working Examples are intended to further describe the invention. It is understood that the invention described in this specification is not necessarily limited to the examples described in this section. Components that are mentioned elsewhere in the specification as suitable alternative materials for use in the invention, but which are not demonstrated in the working Examples below, are expected to provide results comparable to their demonstrated counterparts. Unless otherwise indicated, all parts are by weight.

### EXAMPLES

GPC: Mₙ as used herein, refers to the number average molecular weight (expressed in Da) and means the theoretical value as determined by Gel Permeation Chromatography using A Waters 2695 separation module with a Waters 410 differential refractometer (RI detector) and polystyrene standards. The Mₙ values reported according to the invention were determined using this method. Tetrahydrofuran (THF) was used as the eluent at a flow rate of 1 ml min-1, and two PL Gel Mixed C columns were used for separation.

### Example A

A Non-Aqueous Dispersion (NAD-1) was prepared as detailed below using the materials described in Table 1.

TABLE 1

| | |
|---|---|
| Ingredients | Parts by weight |

Charge #1

| | |
|---|---|
| ISOPAR E¹ | 20.0 |
| PRIPOL 2030² | 194.3 |

Charge #2A

| | |
|---|---|
| Methyl Methacrylate³ | 11 |
| Polyester stabilizer⁴ | 31 |

Charge #2B

| | |
|---|---|
| VAZO 67⁵ | 0.62 |
| Butyl acetate | 1.75 |
| ISOPAR E | 10.0 |

Charge #3

| | |
|---|---|
| MMA | 114.40 |
| THERM-CHEK 837⁶ | 3.75 |
| Hydroxyethyl acrylate ⁷ | 113.15 |
| Polyester stabilizer | 145.0 |

Charge #4

| | |
|---|---|
| VAZO 67 | 1.26 |
| Butyl acetate | 1.75 |
| ISOPAR E | 50.0 |

Charge #5

| | |
|---|---|
| PRIPOL 2030 | 93.38 |

¹ISOPAR E is a C8-9 isoparaffin, commercially available from ExxonMobil Chemical.
²PRIPOL 2030 is a dimerized fatty acid diol, commercially available from Croda International Plc.
³Methyl methacrylate is commercially available from Evonik Industries.
⁴Prepared as described in Examples 1 and 2 in U.S. Pat. No. 9,752,025
⁵VAZO 67 is 2,2′-Azobis(2-methylbutyronitrile), available from E. I. DuPont de Nemours.
⁶THERM-CHEK 837 is a dibutyl tin maleate ester commercially available from Valtris Specialty Chemicals.
⁷ Hydroxyethyl acrylate is commercially available from BASF.

Charge #1 was added into a 2-liter, 4-necked flask equipped with a motor-driven steel stir blade, a thermo couple, a nitrogen inlet, and a water-cooled condenser. The reaction mixture was heated to 95° C., by a mantle controlled by the thermocouple via a temperature feedback control device. At 95° C., Charge #2A was added over 15 minutes and held for 5 minutes. Then Charge #2B was added over 15 minutes and held for 30 minutes. After the hold, Charge #3 and 67% of Charge #4 were added via addition funnel over 3 hours simultaneously. After completion of addition, the reaction mixture was held at 95° C. for 1 hour. After the hold, the rest of Charge #4 was added over 10 minutes, and then the reaction mixture was held at 95° C. for 1 hour. After the hold, Charge #5 was added to drop the temperature to 50° C. and poured out. The non-aqueous dispersion thus obtained had a volume average particle size of 148.9 nm (measured by ZETASIZER).

### Example B

A Non-Aqueous Dispersion (NAD-2) was prepared as detailed below using the materials described in Table 2.

TABLE 2

| | |
|---|---|
| Ingredients | Parts by weight |

Charge #1

| | |
|---|---|
| ISOPAR E | 90.0 |
| VYBAR 6175¹ | 194.3 |

Charge #2A

| | |
|---|---|
| Methyl Methacrylate | 11.0 |
| Polyester stabilizer | 21.3 |

Charge #2B

| | |
|---|---|
| VAZO 67 | 0.62 |
| Butyl acetate | 1.75 |
| ISOPAR E | 15.0 |

Charge #3

| | |
|---|---|
| Methyl Methacrylate | 114.40 |
| THERM-CHEK 837 | 3.75 |
| Hydroxyethyl acrylate | 118.15 |
| Polyester stabilizer | 74.50 |

Charge #4

| | |
|---|---|
| VAZO 67 | 1.26 |
| Butyl acetate | 1.75 |
| ISOPAR E | 80.0 |

Charge #5

| | |
|---|---|
| VYBAR 6175 | 93.38 |

¹VYBAR 6175 is a hydroxyl functional branched polyolefin commercially available from Baker Hughes.

Charge #1 was added into a 2-liter, 4-necked flask equipped with a motor-driven steel stir blade, a thermo couple, a nitrogen inlet, and a water-cooled condenser. The reaction mixture was heated to 95° C., by a mantle controlled by the thermocouple via a temperature feedback control device. At 95° C., Charge #2A was added over 15 minutes and held for 5 minutes. Then Charge #2B was added over 15 minutes and held for 30 minutes. After the hold, Charge #3 and 67% of Charge #4 were added via addition funnel over 3 hours simultaneously. After completion of addition, the reaction mixture was held at 95° C. for 1 hour. After the hold, the rest of Charge #4 was added over 10 minutes, and then the reaction mixture was held at 95° C. for 1 hour. After the hold, Charge #5 was added to drop the temperature to 50° C. and poured out. The non-aqueous dispersion thus obtained had a volume average particle size of 152 nm (measured by ZETASIZER).

### Example C

A Non-Aqueous Dispersion (NAD-3) was prepared as detailed below using the materials described in Table 3.

TABLE 3

| | |
|---|---|
| Ingredients | Parts by weight |

Charge #1

| | |
|---|---|
| Isopar E¹ | 151.00 |
| Pripol 2030² | 531.00 |

Charge #2A

| | |
|---|---|
| Methyl Methacrylate³ | 8.17 |
| Hydroxyethyl acrylate ⁷ | 17.50 |
| Polyester stabilizer⁴ | 19.16 |

Charge #2B

| | |
|---|---|
| Vazo 67⁵ | 2.16 |
| Butyl acetate | 6.00 |
| Isopar E | 35.00 |

Charge #3

| | |
|---|---|
| MMA | 431.55 |
| DAAM⁶ | 35.96 |
| Hydroxyethyl acrylate ⁷ | 251.74 |
| Polyester stabilizer | 246.70 |

Charge #4

| | |
|---|---|
| Vazo 67 | 4.39 |
| Butyl acetate | 10.00 |
| Isopar E | 78.00 |

Charge #5

| | |
|---|---|
| Pripol 2030 | 326.81 |

¹Isopar E is commercially available from Exxon Mobil Corporation.
²Pripol 2030 is commercially available from Croda.
³Methyl methacrylate is commercially available from Evonik Industries.
⁴The preparation of a polyester stabilizer was described as example1 and 2 in U.S. Pat. No. 9,752,025
⁵VAZO 67 is 2,2′-Azobis(2-methylbutyronitrile), available from DuPont.
⁶DAAM is Diacetone acrylamide and commercially available from KH Neochem Co.
⁷ Hydroxyethyl acrylate is commercially available from BASF.

Charge #1 was added into a 3-liter, 4-necked flask equipped with a motor-driven steel stir blade, a thermo couple, a nitrogen inlet, and a water-cooled condenser. The reaction mixture was heated to 95° C., by a mantle controlled by the thermocouple via a temperature feedback control device. At 95° C. Charges #2A was added over 15 minutes and held for 5 minutes. Then charge #2B was added over 15 minutes and held for 30 minutes. After the hold, charge #3 and 67% of Charge #4 were added via addition funnel over 3 hours simultaneously. After completion of addition, the reaction mixture was held at 95° C. for 1 hour. After the hold, the rest of Charge #4 was added over 10 minutes, and then the reaction mixture was held at 95° C. for 1 hour. After the hold, charge #5 was added to drop the temperature to 50° C. and poured out. The non-aqueous dispersion in wax form at room temperature was obtained.

### Example D

A polyester and pigment dispersion paste was prepared from the components listed in Table 4 below.

TABLE 4

| Component | Supplier | Parts by weight |
|---|---|---|
| Polyester polymer¹ | | 16.59 |
| Disperbyk 145 | BYK Chemie | 0.71 |
| BARTEX 10 barium | TOR Minerals Intl. | 7.02 |
| sulfate | | |
| ASP-200 CHINA CLAY | BASF | 4.47 |
| WOLLASTOCOAT | Imerys Performance | 3.83 |
| 10AS extender pigment | Additives | |
| LO-VEL 8100 WAX | PPG | 0.64 |
| TREATED SILICA | | |
| NICRON 665 talc | Imerys Performance | 7.81 |
| | Additives | |
| Zinc Phosphate | | 1.56 |
| Tiona 595 Titanium | Cristal Global | 41.47 |
| dioxide | | |
| MONARCH 1300 | Cabot Corp. | 0.38 |
| Carbon Black | | |
| SOLVESSO 100 | ExxonMobil Chemicals | 15.53 |

¹Polyester prepared in accordance with Example 2 in U.S. Pat. No. 5,468,802.

Curable film-forming compositions were prepared using ingredients according to Table 5 below. Example 1 is a comparative example, demonstrating the preparation of a curable film-forming composition using a standard polyester resin formulation with chlorinated polyolefin (CPO) as an adhesion promoter. Examples 2 to 6 demonstrate curable film-forming compositions of the present invention. The non-aqueous dispersions used in Examples 2 to 6 are prepared from a reactive mixture with a metal-containing monomer. Example 2 demonstrates the preparation of a curable film-forming composition with a non-aqueous dispersion prepared in a mixture of isoparaffins having 8 to 12 carbon atoms and a dimerized fatty acid as the organic medium. Example 3 demonstrates the preparation of a curable film-forming composition with a non-aqueous dispersion prepared in a mixture of isoparaffins having 8 to 12 carbon atoms and a hydroxyl functional branched polyolefin as the organic medium. Example 4 is similar to Example 2, prepared to maximize adhesion to the most challenging substrates. Examples 5 and 6 are similar to Example 2, prepared with no cyclohexane and higher solids. Example 7 demonstrates the preparation of a curable film-forming composition with a non-aqueous dispersion prepared in a mixture of isoparaffins having 8 to 12 carbon atoms and a dimerized fatty acid diol as the organic medium.

TABLE 5

| | Example 1 | | | | | | |
|---|---|---|---|---|---|---|---|
| | (Comparative) | 2 | 3 | 4 | 5 | 6 | 7 |
| Polyester pigment | 27.95 | 25.19 | 24.85 | 25.51 | 30.74 | 29.02 | 25.76 |
| dispersion paste | | | | | | | |
| of Example D | | | | | | | |
| NAD-1 | | 12.05 | | 11.65 | 13.30 | 19.35 | |
| NAD-2 | | | 11.89 | | | | |
| NAD-3 | | | | | | | 18.09 |
| Polyester | 12.08 | | | | | | |
| polymer² | | | | | | | |
| SUPERCHLON | 6.79 | 6.83 | 6.73 | 6.55 | 7.48 | 4.35 | 8.31 |
| JF428S³ | | | | | | | |
| SUPERCHLON | 6.79 | 6.83 | 6.73 | 6.55 | 7.48 | 4.35 | 8.31 |
| 822S⁴ | | | | | | | |
| TEGO | | | | | | 4.35 | |
| ADDBOND | | | | | | | |
| LWT-B⁵ | | | | | | | |
| Dibutyltin | 0.23 | 0.20 | 0.20 | 0.21 | 0.25 | 0.22 | 0.27 |
| Diacetate | | | | | | | |
| SILQUEST | 1.52 | 1.46 | 1.44 | 1.48 | 1.66 | 1.45 | 1.45 |
| A-187⁶ | | | | | | | |
| Cyclohexane | 16.21 | 26.75 | 25.89 | 38.58 | | | |
| T-butyl acetate | 14.03 | 9.08 | 10.80 | | 25.00 | 20.93 | 35.62 |
| SOLVESSO | 1.91 | 1.57 | 1.54 | | 3.30 | | |
| 100⁷ | | | | | | | |
| DESMODUR | 12.50 | 10.04 | 9.91 | 9.47 | 10.80 | 15.96 | 11.83 |
| XP 2410⁸ | | | | | | | |

²Polyester prepared in accordance with Example 2 in U.S. Pat. No. 5,468,802.
^{3, 4}chlorinated polyolefin available from Nippon Paper Group.
⁵Polyester in n-butyl acetate (60% resin solids), available from Evonik Operations GmbH
⁶Epoxy functional silane available from Momentive Performance Chemicals
⁷Aromatic fluid-based solvent available from ExxonMobil Chemicals
⁸Polyisocyanate available from Covestro AG.

Each composition was spray applied to each of ACT cold rolled steel (CRS) Clean Unpolished Item #10288, available from ACT Test Panels LLC; Lyondell Basell Hifax TRC779X (4″×12″×0.118″) thermoplastic olefin (TPO) panels, available from Standard Plaque Inc.; MC80002 polycarbonate/Acrylonitrile Butadiene Styrene (PC/ABS) panels, available from SABIC Innovative Plastics (GE Plastics); Profax SB891 polypropylene (PP) panels, available from LyondellBasell Industries; and Tong-Yang TPO panels, available from Tong-Yang Group. Substrates were prepared for coating with PPG OneChoice SU4901 Clean and Scuff Sponge prior to coating application.

Viscosity of each composition was measured at 25° C. according to ASTM D4287-00 with a Brookfield CAP2000+Viscometer at 900 seconds-1 shear rate with a #4 Spindle. Adhesion was measured 24 hours after application of solventborne color basecoat (DBC9700 DELTRON DBC, available from PPG) and solventborne urethane clearcoat (D4000 DELTRON Urethane Clearcoat, available from PPG) according to ISO 2409, Third Edition published 2007 May 15, using a single-blade cutting tool and a spacing of 2 mm between cuts. Humidity adhesion was measured using the same method after subjecting the coated panels to 100% humidity conditions for 240 hours. Note that a rating of 0-2 is a passing rating, with 0 indicative of a 100% (pass); 1 is indicative of a 90% (pass), etc., up to 5 is indicative of a 0% (fail), as defined in the test. Results are reported in Table 6 below.

TABLE 6

| | Example 1 | | | | | | |
|---|---|---|---|---|---|---|---|
| | (Comparative) | 2 | 3 | 4 | 5 | 6 | 7 |
| Solids (percent by | 53.59 | 47.31 | 46.93 | 46.50 | 54.39 | 62.78 | 54.86 |
| weight as applied) | | | | | | | |
| VOC (#/gal) | 4.15 | 4.50 | 4.50 | 4.50 | 4.21 | 3.50 | 3.91 |
| VOC Less | 3.50 | 4.16 | 4.11 | 4.50 | 2.80 | 2.10 | 2.46 |
| Exempt¹ (#/gal) | | | | | | | |
| Viscosity (cps) | 40 | 32 | 26 | 37 | 48 | 78 | 85 |
| ADHESION | | | | | | | |
| MC80002 | 1 | 0 | 0 | 0 | 0 | 0 | 0 |
| PC/ABS | | | | | | | |
| Hifax 779X TPO | 0 | 0 | 0 | 0 | 0 | 0 | 0 |
| Profax SB891 | 4 | 0 | 0 | 0 | 1 | 0 | 0 |
| PP | | | | | | | |
| Tong-Yang TPO | 3 | 0 | 1 | 0 | 0 | 2 | 0 |
| Cold rolled steel | 0 | 0 | 0 | 0 | 0 | 0 | 0 |
| HUMIDITY | | | | | | | |
| ADHESION | | | | | | | |
| MC80002 | 2 | 0 | 0 | 0 | 0 | 0 | 0 |
| PC/ABS | | | | | | | |
| Hifax 779X TPO | 0 | 0 | 0 | 0 | 0 | 0 | 0 |
| Profax SB891 | 4 | 0 | 0 | 0 | 0 | 1 | 0 |
| PP | | | | | | | |
| Tong-Yang TPO | 5 | 1 | 1 | 0 | 1 | 1 | 1 |
| Cold rolled steel | 0 | 0 | 0 | 0 | 0 | 0 | 0 |

¹Exempt as per USEPA.

The results presented in Table 6 indicate that compositions of the present invention, which have high solids content (most notably, Examples 5 to 7) and low VOC, offer excellent adhesion over a variety of substrates even after humidity exposure. Whereas particular embodiments of this invention have been described above for purposes of illustration, it will be evident to those skilled in the art that numerous variations of the details of the present invention may be made without departing from the scope of the invention as defined in the appended claims.

1. A curable film-forming composition comprising:
(a) a polyisocyanate; and
(b) a dispersion comprising a polymer dispersed in an organic medium and prepared from an ethylenically unsaturated monomer having functional groups that are reactive with the polyisocyanate (a), wherein the organic medium comprises a diluent having functional groups that are reactive with the polyisocyanate (a), said diluent comprising at least one of castor oil, a dimerized fatty acid diol, a hydroxyl functional branched polyolefin oil, a cashew nutshell liquid (CNSL)-based diol, a polycaprolactone-based polyol, an alkoxylated diol comprising a hydroxyl group wherein the diol contains 2 to 6 carbon atoms prior to alkoxylation; an alkoxylated triol comprising a hydroxyl group, wherein the triol contains 2 to 6 carbon atoms prior to alkoxylation, and an alkoxylated tetrol comprising a hydroxyl group, wherein the tetrol contains 2 to 6 carbon atoms prior to alkoxylation;
wherein the curable film-forming composition has a solids content of at least 45 percent by weight, and at most 72 percent by weight, based on the total weight of the curable film-forming composition, and demonstrates a blended, application viscosity of at most 100 centipoise,
when measured at 25° C. according to ASTM D4287-00 with a Brookfield CAP2000+ Viscometer at 900 seconds 1 shear rate with a #4 Spindle.

2-3. (canceled)

4. The curable film-forming composition of claim 1, wherein the dispersion (b) comprises a non-aqueous dispersion, which in turn comprises a dispersion polymerization reaction product of: (i) a monomer mixture comprising a metal-containing ethylenically unsaturated monomer and the ethylenically unsaturated monomer having functional groups that are reactive with the polyisocyanate (a), and (ii) a polymeric stabilizer; and wherein the dispersion polymerization reaction product is dispersed in the organic medium.

5-6. (canceled)

7. The curable film-forming composition of claim 4 wherein the metal-containing ethylenically unsaturated monomer is selected from at least one of dibutyltin maleate, dibutyltin diacrylate, dibutyltin monoacrylate, and zinc (meth) acrylate.

8. The curable film-forming composition of claim 4 wherein the polymeric stabilizer (ii) comprises an aliphatic polyester and/or an aliphatic poly (meth) acrylate.

9. The curable film-forming composition of claim 4 wherein the polymeric stabilizer (ii) comprises an aliphatic polyester that is prepared from 12-hydroxystearic acid and/or ricinoleic acid.

10. The curable film-forming composition of claim 1 wherein the organic medium further comprises a mixture of isoparaffins having 8 to 12 carbon atoms.

11. The curable film-forming composition of claim 1, further comprising (c) an adhesion promoter, wherein the adhesion promoter (c) comprises (i) a non-chlorinated, linear polyolefin polymer prepared from a reaction mixture comprising 0.5 to 10 percent by weight maleic anhydride based on the total weight of monomers in the reaction mixture, and/or (ii) a chlorinated polyolefin.

12. (canceled)

13. The curable film-forming composition of claim 11 wherein the adhesion promoter (c) comprises the non-chlorinated linear polyolefin polymer (i), which is further reacted with a polyepoxide and a monohydric alcohol.

14. (canceled)

15. The curable film-forming composition of claim 11, wherein adhesion promoter (c) comprises the non-chlorinated linear polyolefin polymer (i), and the reaction mixture used to prepare the non-chlorinated, linear polyolefin polymer (i) further comprises an ethylenically unsaturated monomer comprising at least one (meth) acrylic monomer.

16. The curable film-forming composition of claim 11 wherein the adhesion promoter (c) comprises the chlorinated polyolefin (ii).

17. A coated article comprising a substrate and the curable film-forming composition of claim 1 applied directly to at least one surface of the substrate.

18. The coated article of claim 17 wherein after curing the curable film-forming composition on the substrate, the coated article demonstrates an adhesion rating of 0 to 2 when subjected to ISO 2409, Third Edition published 2007 May 15, using a hand-held single-blade cutting tool and a spacing of 2 mm between cuts.

19. The coated article of claim 17, wherein the substrate comprises a metal, a thermosetting polymer, a thermoplastic polymer, an elastomer, or a composite.

20. A coated article comprising at least two different substrates and the curable film-forming composition of claim 1 applied directly to at least one surface of each of the substrates.

21. The coated article of claim 20, wherein after curing the curable film-forming composition on the substrates, the coated article demonstrates an adhesion rating of 0 to 2 on each of the substrates when subjected to ISO 2409, Third Edition published 2007 May 15, using a single-blade cutting tool and a spacing of 2 mm between cuts.

22. (canceled)

23. The coated article of claim 17, wherein the coated article comprises a component of a vehicle, building, bridge, industrial protective structure, construction equipment structure, ship, railcar, railcar container, water tower, power line tower, tunnel, oil or gas industry structure, marine structure, aerospace structure, bridge support structure, pipeline, oil rig, storage tank, or wind turbine.

24. A vehicle component comprising:
(A) a substrate having at least one coatable surface, and
(B) a primer or primer-sealer coating applied directly to at least one surface of the substrate, wherein the primer or primer-sealer coating comprises the curable film-forming composition of claim 1.

25. (canceled)

26. The vehicle component of claim 24, wherein the substrate comprises a metal, a thermosetting polymer, a thermoplastic polymer, an elastomer, or a composite.

27. The vehicle component of claim 24, further comprising (C) at least one additional coating layer applied on top of the coating (B), wherein the at least one additional coating layer (C) comprises a basecoat and/or direct gloss topcoat.

28. (canceled)

29. A coating kit comprising:
(a) a polyisocyanate; and
(b) a dispersion comprising a polymer dispersed in an organic medium and prepared from an ethylenically unsaturated monomer having functional groups that are reactive with the polyisocyanate (a), wherein the organic medium comprises a diluent having functional groups that are reactive with the polyisocyanate (a), said diluent comprising at least one of castor oil, a dimerized fatty acid diol, a hydroxyl functional branched polyolefin oil, a cashew nutshell liquid (CNSL)-based diol, a polycaprolactone-based polyol, an alkoxylated diol comprising a hydroxyl group wherein the diol contains 2 to 6 carbon atoms prior to alkoxylation; an alkoxylated triol comprising a hydroxyl group, wherein the triol contains 2 to 6 carbon atoms prior to alkoxylation, and an alkoxylated tetrol comprising a hydroxyl group, wherein the tetrol contains 2 to 6 carbon atoms prior to alkoxylation;
wherein the coating kit comprises multiple, separate components, wherein a first component comprises the polyisocyanate (a) and a second component comprises the dispersion (b);
and wherein the coating kit has a solids content of at least 45 percent by weight, and at most 72 percent by weight, based on the total weight of the coating kit, and demonstrates a blended, application viscosity of at most 100 centipoise, when measured at 25° C. according to ASTM D4287-00 with a Brookfield CAP2000+ Viscometer at 900 seconds 1 shear rate with a #4 Spindle.

30. (canceled)

31. The coating kit of claim 29, further comprising (c) an adhesion promoter.

32-33. (canceled)
